(19) United States
(12) Patent Application Publication
(10) Pub. No.: US 2019/0381868 A1
(43) Pub. Date: Dec. 19, 2019

(54) Vehicle Sun Shade

(71) Applicant: Charlene F Chessum, (US)

(72) Inventor: Charlene F Chessum, (US)

(21) Appl. No.: 15/496,131

(22) Filed: Apr. 25, 2017

(51) Int. Cl. B60J 1/20

(52) U.S. Cl. CPC B60J 1/2091

(57) ABSTRACT

Generally sun shades shield the front, side or rear windows of a vehicle separately. A typical sedan would need 6 shades. A typical pick up would need 4 shades. To shield a single seat from the sun using the current invention would take 2 shades. Most sun shades designed for the side window of a vehicle leave spaces on the window unprotected allowing sunlight through into the inside of the vehicle.

This invention cuts the number of shades required In half and protects more of the vehicle. Protecting the driver's side of the vehicle would require one shade opposed to two. Protecting the passenger's side of the vehicle would require one shade opposed to two. Protecting the entire front of the vehicle would require two shades opposed to three. This invention also provides greater coverage than the traditional sun shades. Traditional sun shades typically leave the edges of the side windows unprotected.

Sunshades for vehicles of various designs have been used to keep the interior of a vehicle cooler and/or to protect the materials in the interior from the sun and sun damage. Sunshades are typically made out of cardboard or a sun reflective material. Typically, the sunshade folds in an accordion manner, twists using a flexible frame, or roll up in a housing that fits on the interior of a vehicle.

Sunshades that are used on the interior of the vehicle have become easier to use and store. They can now fit between the seats in a vehicle or in the storage area behind a seat.

Sunshades that are used on the exterior of your vehicle can usually take care of your vehicle using only 1 sunshade. There is a sunshade that cover the windshield and is held in place by gripping the side mirrors, one that covers the entire top of the vehicle—all the windows and the roof, one that sits on top of a frame that hooks to the side of the car creating a small carport that is self-supported by the vehicle. There are car covers that cover the entire vehicle.

The problem with these solutions is that it takes a number of shades that either don't cover the entire section that needs to be covered or they are used on the exterior of the vehicle allowing the user to deal with possible bad weather such as precipitation and wind.

This Vehicle Sunshade allows the user to cover an entire area with 2 sunshades or 4 sunshades. A single sunshade can cover the entire front seat (windshield and drivers side and passenger side windows) or two sunshades can be used—one covering half the windshield and the driver's side window and one covering half the windshield and the passenger side window. The two sunshade method would overlap in the center.

### SUMMARY

The Vehicle Sun Shade covers the entire interior of the vehicle with less effort and more coverage than existing interior sunshade covers.

### DESCRIPTION OF THE DRAWINGS

FIG. 1—Shows the shape of each Vehicle Sun Shade when not in use and lying flat.

FIG. 2—Shows the Vehicle Sun Shade if it were made out of paper, cardboard, or some other paper product.

FIG. 3—Shows the Vehicle Sun Shade if it were made out of cloth or fabric. Some would use a reflective cloth or fabric to keep the car even cooler.

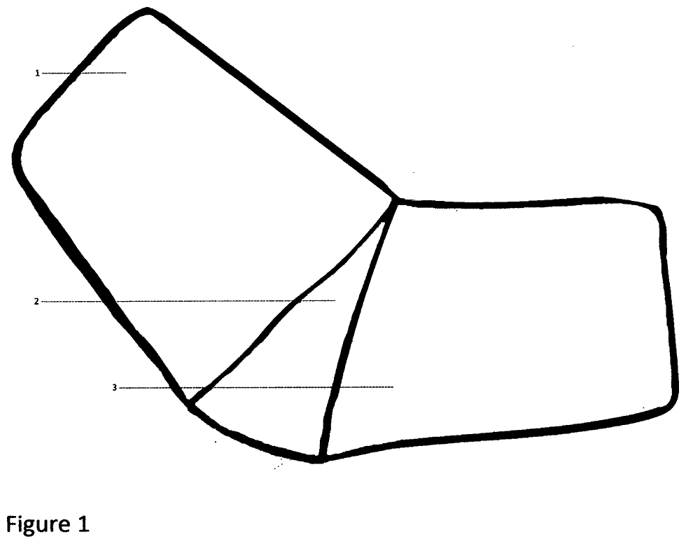

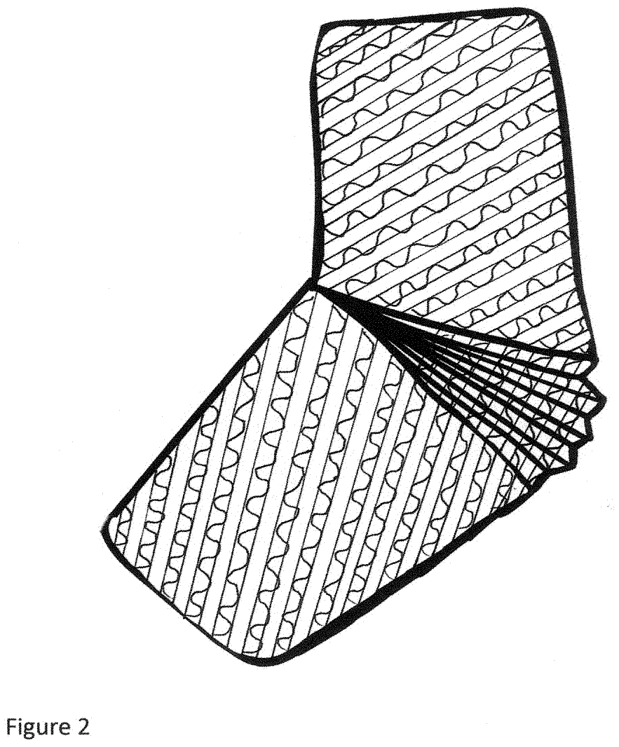

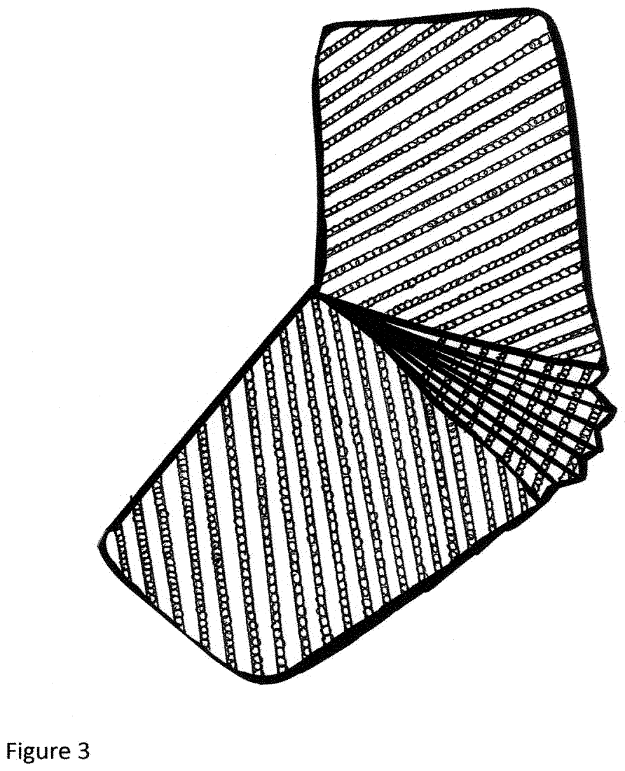

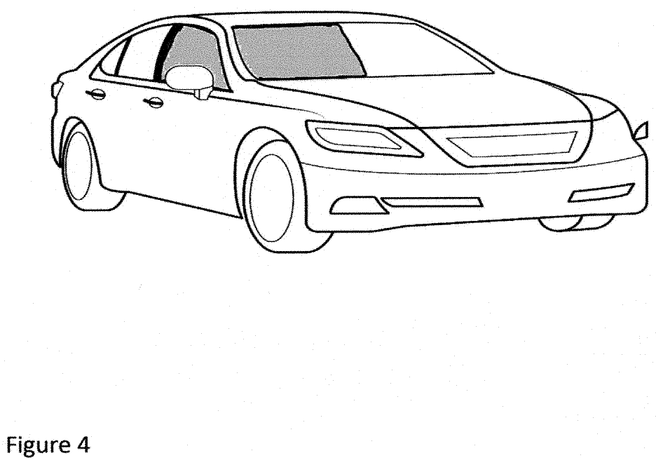

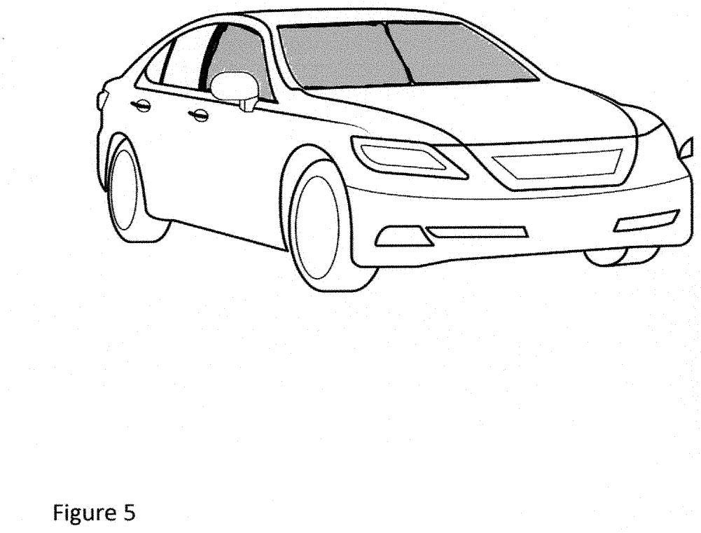

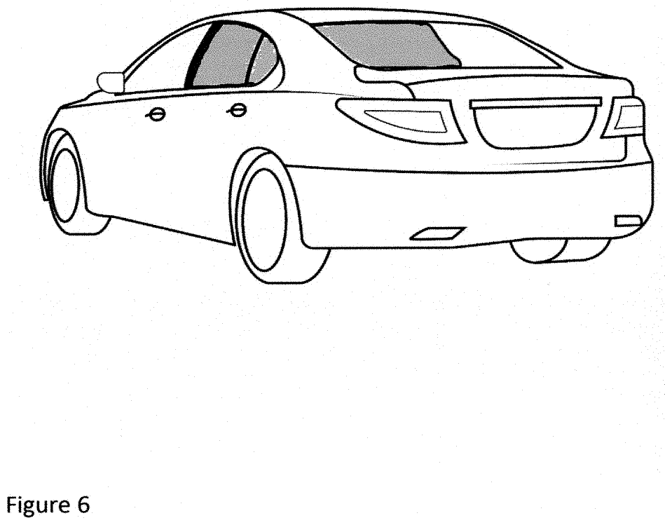

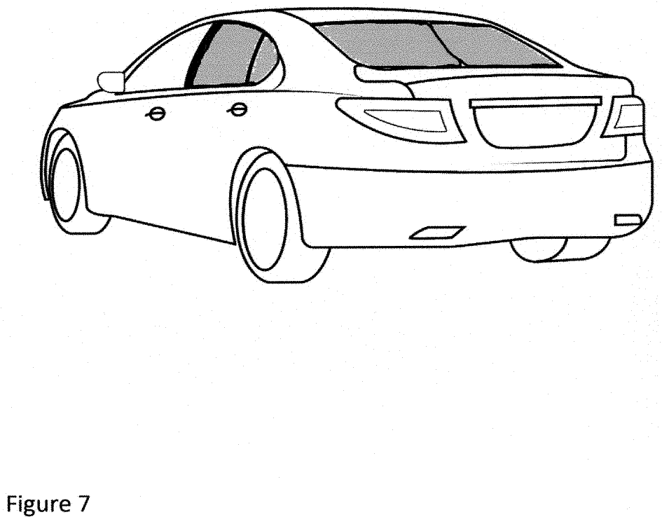

VEHICLE SUN SHADE—FIG. 4 Vehicle Sun shade shows the layout with: 1 covering the windshield, FIG. 5 shows 2 shades covering the entire front of the vehicle. FIG. 6 is covering the side window and drivers side of the backseat. This Vehicle Sun Shade can be made out of a reflective material, insulated material, cardboard, UV reflective material or any material to that would be flexible enough to cover the windshield and windows and easy enough to fold and move out of the way. It is best to make it out of a reflective insulated material to maximize the sunlight and heat penetration into the vehicle.

FIG. 4—Image of the Vehicle Sun Shade shows the Vehicle Sun Shade being used on the passenger side of the vehicle. The Vehicle Sun Shade is covering the passenger half of the windshield and the entire passenger side window.

FIG. 5—Image of the Vehicle Sun Shade shows the Vehicle Sun Shade being used on the entire front of the vehicle and the passenger side window. It is also on the driver's side of the window (not pictured).

FIG. 6—Image of the Vehicle Sun Shade shows the Vehicle Sun Shade being used on the driver's side rear seat and the rear window. This is one Vehicle Sun Shade that covers these two areas.

FIG. 7—Image of the Vehicle Sun Shade shows the Vehicle Sun Shade being used on the entire rear window and the rear passenger window. It is also on the passenger side of the window (not pictured).

### DESCRIPTION OF THE INVENTION

The Vehicle Sun Shade keeps and entire area blocked from the sun. Two Vehicle Sun Shades keeps and entire half of a sedan blocked from the sun. Four Vehicle Sun Shades keep the entire sedan blocked from the sun.

### Patent Citations

US 20040160082A1 Filing Date: Feb. 19, 2004 Publication Date: Aug. 19, 2004 Inventor: Horst Bohm, Assignee: ArvinMeritor GmbH, Title: Sunshade system for a motor vehicle
US 20020167202A1 Filing Date: May 28, 2002 Publication Date: Nov. 14, 2002 Inventor: Manfred Pfalzgraf, Assignee: Webasto Vehicle Systems International GmbH, Title: Sunshade for a motor vehicle roof and motor vehicle roof with a movable cover
U.S. Pat. No. 7,568,752B1 Filing Date: Mar. 4, 2008 Publication Date: Aug. 4, 2009 Inventor: Paul Lin, Assignee: Masauto Ind Co Ltd, Title: Sunshade assembly
U.S. Pat. No. 7,185,694B2 Filing Date: Jan. 22, 2007 Publication Date: Mar. 6, 2007 Inventor: Steven B. Dunn, Assignee: Munchkin Inc., Title: Sun shade for vehicles
US 20090072574A1 Filing Date: Mar. 9, 2008 Publication Date: Mar. 19, 2009 Inventor: Shinji Tominage, Assignee: Toyota Boshoku Corp, Title: Sunshade device
U.S. Pat. No. 7,823,955B2 Filing Date: Jun. 26, 2009 Publication Date: Nov. 2, 2010 Inventor: Stefano Alacqua, Assignee: CRF SCpA, Title: Sunshade device for motor-vehicles, with shape memory actuator
U.S. Pat. No. 6,726,277B1 Filing Date: Oct. 18, 2002 Publication Date: Apr. 27, 2004 Inventor: Thomas J. Samaha, Assignee: Thomas J. Samaha, Title Vehicle seat and steering wheel sunshade
US 20080197122A1 Filing Date: Feb. 13, 2008 Publication Date: Pending (Feb. 21, 2008) Inventor: Kenneth Parks Gober, Assignee: Kenneth Parks Gober, Title Combination defroster panel and sunshade for vehicle glass
US 20050104408A1 Filing Date: Nov. 17, 2004 Publication Date: Pending (May 19, 2005) Inventor: Robert Capps, Assignee: Blue Ridge International Products Co., Title: Photochromic Automobile window sunshade
US 20100013261A1 Filing Date: Jul. 14, 2009 Publication Date: Jan. 21, 2010 Inventor: Kouichi Takeuchi, Assignee: Toyota Boshoki Corp. Title: Vehicle sunshade device
U.S. Pat. No. 7,562,928B1 Filing Date: Mar. 31, 2006 Publication Date: Jul. 21, 2009 Inventor: Harold Morazan, Assignee: Harold Morazan, Title: Automated vehicle sunshade
U.S. Pat. No. 7,493,933B2 Filing Date: Aug. 15, 2015 Publication Date: Feb. 24, 2009 Inventor: Xinia Li, Assignee: Li Xinian, Title: Retractable window shade
U.S. 6,976,523B2 Filing Date: Jun. 2, 2003 Publication Date: Dec. 20, 2005 Inventor: Sunny E. L. Huang, Assignee: Huang Sunny E. L. Title: Collapsible auto shade
US 20050199357A1 Filing Date: Mar. 10, 2004 Publication Date: Pending (Sep. 15, 2005) Inventor: Steven Dunn, Assignee: Dunn Steven B. Title: Shade with thermaochromic temperature sensor
U.S. 8,061,757B1 Filing Date: Sep. 1, 2010 Publication Date: Nov. 22, 2011 Inventor: Jaime Nicole Moore, Assignee: Toyota Motor Engineering and Manufacturing North America Inc. Title: Force assist for sunshade closing slide mechanism
US 20090038766A1 Filing Date: Aug. 6, 2007 Publication Date: Feb. 12, 2009 Inventor: William Louis Smith, J R, Assignee: Smith Jr. William Louis, Title “Car Hat”, a portable sunshade canopy for automobiles
U.S. Pat. No. 8,342,226B2 Filing Date: Sep. 23, 2010 Publication Date: Jan. 1, 2013 Inventor: Yu Zheng, Assignee: Patent Category Corp, Title Collapsible sunshade
US 20110088855A1 Filing Date: Oct. 16, 2009 Publication Date: Apr. 21, 2011 Inventor: Mhd Yaser Boustani, Assignee: Mhd Yaser Boustani, Title: Vehicle sunshade device
US 20050189784A1 Filing Date: Feb. 25, 2005 Publication Date: Sep. 1, 2005 Inventor: Pierre Guerreiro, Assignee: Faurecia Interieur Industrie, Title: Sunshade for a motor vehicle, and a vehicle door equipped with such a sunshade
US 20030006015A1 Filing Date: Jul. 6, 2001 Publication Date: Jan. 9, 2003 Inventor: Paul Lin, Assignee: Paul Lin, Title: Sunshade capable of decomposing air contaminants
US 20130168034A1 Filing Date: Sep. 13, 2011 Publication Date: Jul. 4, 2013 Inventor: Naochika Katada, Assignee: Ashimori Ind Co Ltd, Title: Sunshade device
U.S. Pat. No. 8,256,492B2 Filing Date: Jan. 13, 2011 Publication Date: Sep. 4, 2012 Inventor: Paul Lin, Assignee: Macauto Ind Co Ltd, Title: Frame-mounted sunshade device
U.S. Pat. No. 8,419,119B2 Filing Date: Oct. 12, 2011 Publication Date: Apr. 16, 2013 Inventor: Teruyuki Nakamura, Assignee: Yachiyo Ind Co Ltd, Title: Sunshade device
U.S. Pat. No. 8,002,341B2 Filing Date: Dec. 14, 2009 Publication Date: Aug. 23, 2011 Inventor: Kouichi Hotta, Assignee: Yachiyo Ind Co Ltd, Title: Roll sunshade device
U.S. Pat. No. 8,434,817B2 Filing Date: Sep. 23, 2011 Publication Date: May 7, 2013 Inventor: Kazuki Sawada, Assignee: Aisin Seiki Co Ltd, Title: Sunshade for vehicle
US 20050028948A1 Filing Date: Sep. 7, 2004 Publication Date: Feb. 10, 2005 Inventor: Lee Austin, Assignee: Lee Austin, Title: Sunshade for vehicles
US 20110017412A1 Filing Date: Jul. 21, 2009 Publication Date: Pending (Jan. 27, 2011) Inventor: David F. MacNeil, Assignee: MacNeil IP LLC, Title: Reversible sunshade
US 20186756A1 Filing Date: Jan. 24, 2011 Publications Date: Pending (Jul. 26, 2012) Inventor: Paul Lin, Assignee: Macauto Ind Co Ltd, Title: Sunshade device for a rear window of a vehicle
U.S. Pat. No. 8,308,217B2 Filing Date: Sep. 8, 2009 Publication Date: Nov. 13, 2013 Inventor: Rameshbhai Kalabhai Patel, Assignee: Rameshbhai Kalabhai Patel, Title: Automobile sun visor with electromechanical sun shade and methods of use thereof
U.S. Pat. No. 7,367,614B2 Filing Date: Dec. 15, 2006 Publication Date: May 6, 2008 Inventor: Tatsuaki Uehara, Assignee: Yachiyo Ind Co Ltd, Title: Multi-panel sunshade device
US 20050073169A1 Filing Date: Aug. 27, 2004 Publication Date: Apr. 7, 2005 Inventor: Larry Kamerer, Assignee: Fernco Inc., Title: Removable and adjustable sun shade for roll bar equipped vehicles
U.S. Pat. No. 8,215,697B1 Filing Date: Jul. 10, 2012 Publication Date: Jul. 10, 2012 Inventor: Paul Lin, Assignee: Macauto Ind Co Ltd, Title: Sunshading apparatus mountable on a rear window of a vehicle
US 20120049564A1 Filing Date: Aug. 30, 2010 Publication Date: Mar. 1, 2012 Inventor: Charles Stephen Haase, Assignee: Hondo Motor Co Ltd, Title: Sunshade assembly for a vehicle
US 20120111512A1 Filing Date: Aug. 20, 2010 Publication Date: May 10, 2012 Inventor: Naochika Katada, Assignee: Ashimori Ind Co Ltd, Title: Sunshade device

1. (canceled)

2. (canceled)

3. (canceled)

4. A vehicle sun shade apparatus comprising: two panels that join together to create a single unit that covers the windshield and the side windows in the front.

5. A vehicle sun shade apparatus comprising: four panels that together cover the windshield, rear side windows, front side windows and the back window.
